(19) United States
(12) Patent Application Publication
(10) Pub. No.: US 2018/0154841 A1
(43) Pub. Date: Jun. 7, 2018

(54) APPARATUS FOR HOLDING ELECTRONIC DEVICES OR OTHER ITEMS IN A VEHICLE

(71) Applicant: Ilgar Roust, Allaman (CH)

(72) Inventor: Ilgar Roust, Allaman (CH)

(21) Appl. No.: 15/367,720

(22) Filed: Dec. 2, 2016

(51) Int. Cl. B60R 11/02

(52) U.S. Cl. CPC B60R 11/02; B60R 2011/0026

(57) ABSTRACT

The present invention relates to an apparatus for holding electronic devices or other items in a vehicle, including a mast adapted to be nipped between a vehicle's dashboard and a vehicle's windshield, mirror stock or ceiling, and a device holder adapted to releasably hold an electronic device or other item, with the device holder being secured to the mast.

### FIELD OF THE INVENTION

The present invention relates to an apparatus for holding electronic devices or other items in a vehicle.

### BACKGROUND OF THE INVENTION

Portable electronic devices, such as phones, media players or navigators, are increasingly popular and are legally used in vehicles.

Few motor vehicles are equipped with suitable electronic device holders that allow a driver or a front seat passenger to easily and conveniently access and interact with such devices. Similarly, conventional in-vehicle device holders are imperfect and have certain limitations or disadvantages. Presently existing holders are attached to the interior of a vehicle in following ways:
1) To a vehicle windshield by a suction cup;
2) To a vehicle dashboard by adhesive materials, screws or weight bags;
3) To a vehicle air vent by a clip/clips;
4) To a vehicle lighter charger socket by a stand inserted into such socket;
5) To a vehicle cup holder by a stand inserted into such holder; and
6) To a vehicle floor, door or other parts of the interior fixed with screws or by welding.

Every mounting option described above has certain disadvantages and limitations. In particular, suction cup mounts—beside obstructing road view—often detach from the windshield causing driver's distraction; dashboard mounts require a use of adhesives or screws and either damage dashboards or remain traces of adhesives; air vent mounts obstruct air circulation, prevent air direction control and limit angle adjustment of the device; lighter socket based or cup holder based or floor based mounts position electronic device out of driver's eyesight, thus causing driver's distraction during use as well as obstruct/limit driver's movements.

Thus, there is a need for an electronic device holder for a vehicle that:
1) Can be firmly installed with no suction cups, with no clips, with no screws, with no adhesive materials, with no weight bags.
2) A holder that is not attached to a windshield of a vehicle and that does not obstruct road view.
3) A holder that not only can alone solidly hold one or more devices/items but also hold heavy items, such as large tablet PCs or laptops.

### SUMMARY OF THE INVENTION

In this view, the present invention relates to an apparatus for holding electronic devices or other items in a vehicle, comprising:
a mast adapted to be nipped between a vehicle's dashboard and a vehicle's windshield, mirror stock or ceiling;
a device holder adapted to releasably hold an electronic device or other item, said device holder being secured to said mast.

Thus configured, the apparatus of the present invention provides a simple to install and stable platform for an electronic device or other item, and allows for the electronic device to be affixed at any positions in the vehicle and at any orientation relative to the driver.

### BRIEF DESCRIPTION OF THE DRAWINGS

Other features and advantages of the present invention will appear more clearly from the detailed description of one embodiment of the invention which is presented solely by way of a non-restricted example and illustrated by the attached drawings in which:

FIG. 1 is a perspective view of an apparatus according to an embodiment of the present invention;

FIG. 2 is an exploded perspective view of the connection element of the apparatus illustrated in FIG. 1.

### DETAILED DESCRIPTION OF AN EMBODIMENT OF THE INVENTION

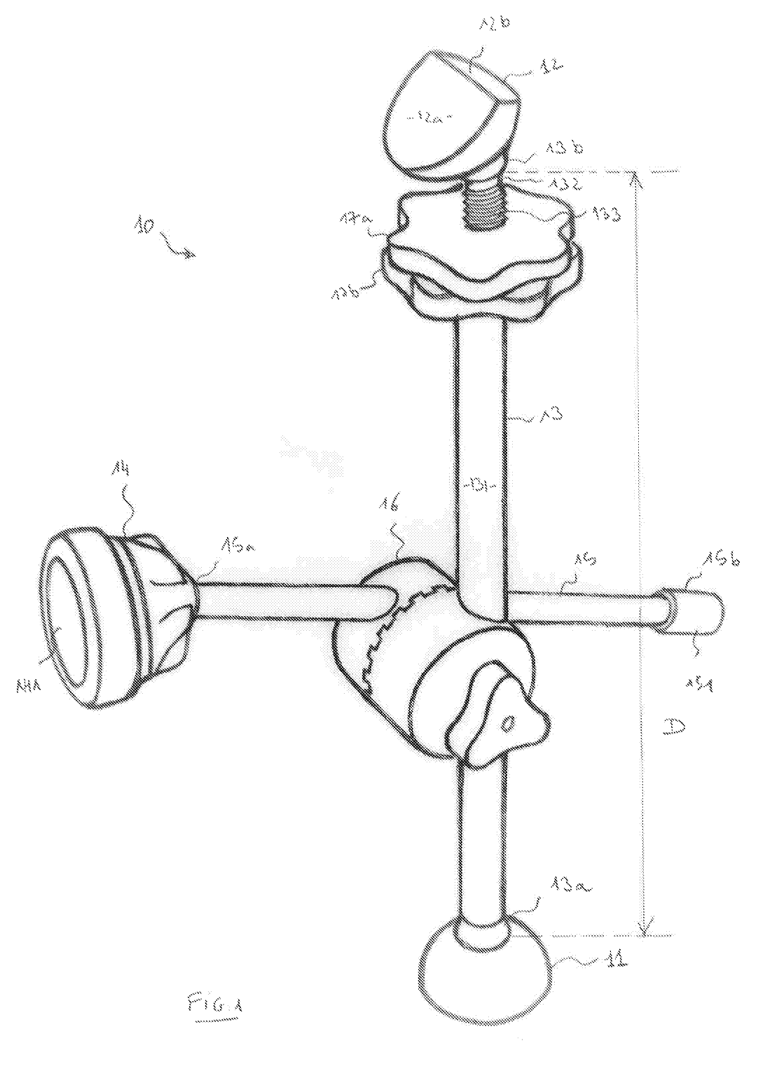

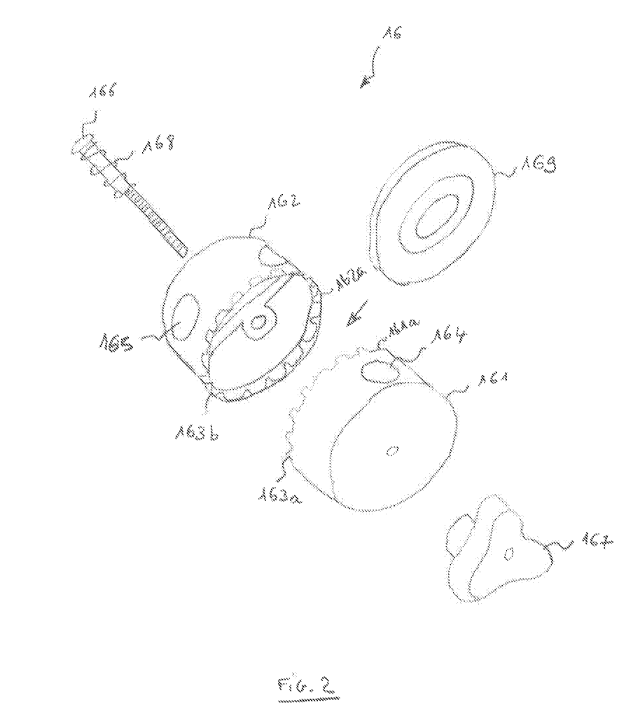

FIGS. 1 and 2 illustrate an apparatus according to the present invention that may be utilized to affix an electronic device or other item inside a vehicle. In this embodiment, the apparatus 10 comprises a first base support 11 intended to lean and push against a vehicle's dashboard, a second base support 12 intended to lean and push against a vehicle's windshield, mirror stock or ceiling, and a mast 13 possessing a first end 13a pivotally secured to said first base support 11 and a second end 13b pivotally secured to said second base support 12. A device holder 14 adapted to releasably hold an electronic device is pivotally connected to an intermediate arm 15 at a first end 15a thereof, the intermediate arm 15 being connected to the mast 13 via a connection element 16. The second base support 12 may advantageously comprise a first plane surface 12a intended to lean against the vehicle's windshield and a second plane surface 12b obliquely oriented relative to said first plane surface 12a, said second plane surface 12b being intended to lean against the rearview mirror stock of the vehicle. The distance D between the first end 13a of the mast 13 and the second end 13b thereof may advantageously be adjustable to adapt the apparatus to any type of vehicle. In the embodiment shown, this adjustment can be done by screwing or unscrewing a second part 132 of the mast 13 relative to a first part 131 thereof, said second part 132 being telescopically received inside said first part 131 and releasably connected thereto. Thus, the second part 132 is at least partially provided with a threaded portion 133 on its external periphery, said threaded portion 133 interacting with a corresponding threaded portion provided along a central cavity of the first part 131 so as to permit an adjustment of the relative position between the first part 131 and the second part 132. A first nut 17a threadedly connected to the threaded portion 133 of the second part 132 may be provided to easily modify the position of said second part 132 relative to the first part 131. A second nut 17b threadly connected to the threaded portion 133 and positioned under the first nut 17a may be provided to lock said first nut 17a in a specific position, thus preventing that a modification of the length of the mast 13 occurs during the normal use of the apparatus. Thus configured, the apparatus 10 can be nipped between a vehicle's dashboard and a vehicle's windshield, mirror stock or ceiling by a force created by the thread expansion mechanism. Other expansion mechanisms, for example a hydraulic expansion mechanism, may also be used. The device holder 14 incorporates a magnet 141 that is adapted to interact with a metallic portion of an electronic device or other item so as to permit the removable connection of said electronic device or said other item to the device holder 14. Other connecting means may be provided instead of the magnet. For example, the device holder 14 may incorporate a grasping element adapted to removably connect the electronic device or other item to the device holder.

The connection element 16 may be configured so that the position of said connection element 16 along the mast 13 and/or along the intermediate arm 15 can be easily adjusted. The connection element 16 may also be configured so that the angular position between the mast 13 and the intermediate arm 15 can be easily adjusted. A preferred configuration for the connection element is illustrated in FIG. 2. In this configuration, the connection element 16 comprises a first cylindrical part 161 connected to a second cylindrical part 162 through interconnecting teeth 163a, respectively 163b, provided around a circular edge 161a, respectively 162a, of the first, respectively second, cylindrical part. The first and second cylindrical parts are removably connected together through a screw 166 and a nut 167. A compression spring 168 is advantageously provided around the threaded rod of the screw 166 to resiliently bias the first cylindrical part of the second cylindrical part. A central washer 169 may be positioned between said first and second cylindrical parts 161, 162. Said central washer 169 is adapted to press against the mast 13 that is partially received in a through hole 164 provided in the first cylindrical part 161, and against the intermediate arm 15 that is partially received in a through hole 165 provided in the second cylindrical part 162. Thus, by unscrewing the nut 167, a user can partially separate the first and second cylindrical parts 161, 162 and, thereafter, modify the relative angular position between the mast 13 and the intermediate arm 15. Furthermore, by releasing the pressure against the central washer 169, it is also possible to move the mast 13 inside the through hole 164 and/or to move the intermediate arm 15 inside the through hole 165. As illustrated in FIG. 1, an abutment 151 may advantageously be provided at one other end 15b of the intermediate arm 15, said abutment 151 being intended to abut against the second cylindrical part 162 in a specific position of the intermediate arm 15, said specific position corresponding to the maximum extension of said intermediate arm.

In further embodiments (not shown) of the present invention, the device holder 14 may also be directly connected to the mast 13. The mast 13 may also be provided with several branches and/or with more than two ends. The mast 13 may also be configured so as to receive a perfume diffuser or a perfume capsule. The apparatus may also comprise several intermediate arms permitting the connection of other electronic devices or other items.

The above detailed description with reference to the drawings illustrates rather than limits the invention. There are numerous alternatives, which fall within the scope of the appended claims.

1. Apparatus for holding electronic devices or other items in a vehicle, comprising:
a mast adapted to be nipped between a vehicle's dashboard and a vehicle's windshield, mirror stock or ceiling; and
a device holder adapted to releasably hold an electronic device or other item, said device holder being secured to said mast.

2. Apparatus according to claim 1, further comprising:
at least one first base support intended to lean and push against a vehicle's dashboard;
at least one second base support intended to lean and push against a vehicle's windshield, mirror stock or ceiling;
the mast possessing at least one first end secured to said at least one first base support and at least one second end secured to said at least one second base support.

3. Apparatus according to claim 2, wherein the mast is configured so that the distance between the first end and the second end is adjustable.

4. Apparatus according to claim 3, wherein the mast includes a first part and a second part telescopically received inside said first part and releasably connected thereto, the position of said second part relative to said first part being adjustable.

5. Apparatus according to claim 4, wherein the second part is at least partially provided with a threaded portion on its external periphery, said threaded portion interacting with a corresponding threaded portion provided along a central cavity of the first part so as to permit an adjustment of the distance between the first end and the second end.

6. Apparatus according to claim 1, wherein the device holder incorporates a magnet adapted to interact with a metallic part of the electronic device or other item so as to permit the removable connection of the electronic device or other item.

7. Apparatus according to claim 1, wherein the device holder incorporates a grasping element adapted to removably connect the electronic device or other item to the device holder.

8. Apparatus according to claim 1, wherein the device holder is connected to an intermediate arm, which is connected to the mast via a connection element.

9. Apparatus according to claim 8, wherein the connection element is configured so that the position of the connection element along the mast and/or the intermediate arm is adjustable.

10. Apparatus according to claim 9, wherein the connection element is configured so that the angular position between the mast and the intermediate arm is adjustable.

11. Apparatus according to claim 8, wherein the intermediate arm possesses an end pivotally secured to the device holder.

12. Apparatus according to claim 2, wherein the first end of the mast is pivotally secured to the first base support and the second end of the mast is pivotally secured to the second base support.
